(19) United States
(12) Patent Application Publication
(10) Pub. No.: US 2026/0081520 A1
(43) Pub. Date: Mar. 19, 2026

(54) PFC CIRCUIT

(71) Applicant: LG ELECTRONICS INC., Seoul (KR)

(72) Inventor: Dohoon KIM, Seoul (KR)

(73) Assignee: LG ELECTRONICS INC., Seoul (KR)

(21) Appl. No.: 19/108,330

(22) PCT Filed: May 10, 2023
(86) PCT No.: PCT/KR2023/006315

§ 371 Date: Mar. 3, 2025

(30) Foreign Application Priority Data
Sep. 2, 2022 (KR) 10-2022-0111324

(51) Int. Cl. H02M 1/42; H02M 1/00

(52) U.S. Cl. CPC H02M 1/4208; H02M 1/0003

(57) ABSTRACT

A PFC circuit for outputting a PFC voltage by compensating a power factor of an input voltage of an electronic device according to an embodiment of the present disclosure may comprise: a sensing unit for acquiring an input voltage; and a controller for controlling the PFC voltage on the basis of at least one of the input voltage and a load of the electronic device.

### TECHNICAL FIELD

The present disclosure relates to a power factor corrector (PFC) circuit.

### BACKGROUND ART

A power factor corrector (PFC) circuit reduces power loss that occurs during a process of converting AC power into DC power.

In a PFC circuit according to a related art, a PFC voltage is fixed. That is, a fixed PFC voltage is always output, regardless of an input voltage and a load of an electronic device. Therefore, when the input voltage is low, there occurs a problem in that the number and the size of components in an AC filter increase so as to suppress interference between a resonant frequency of the AC filter and an operating frequency of the PFC circuit. When the input voltage is high, there is a disadvantage in that the PFC voltage is high even when the load is small, which reduces efficiency.

### DISCLOSURE OF INVENTION

### Technical Problem

The present disclosure aims to provide a power factor corrector (PFC) circuit that varies a PFC voltage based on an input voltage and a load.

The present disclosure aims to provide a PFC circuit that minimizes an under-voltage problem when a PFC voltage is varied.

### Solution to Problem

A power factor corrector (PFC) circuit for outputting a PFC voltage by compensating for a power factor of an input voltage of an electronic device according to an embodiment of the present disclosure may include a sensing unit configured to acquire the input voltage and a controller configured to adjust the PFC voltage based on at least one of the input voltage and a load of the electronic device.

The controller may be configured to set the PFC voltage to a first value when the load of the electronic device is a high load, and set the PFC voltage to a second value less than the first value when the load of the electronic device is a low load.

The controller may be configured to acquire the load of the electronic device based on on-time of the PFC circuit.

The controller may be configured to determine the load as a high load when the on-time is greater than a preset reference time, and determine the load as a low load when the on-time is less than the reference time.

The controller may be configured to set the PFC voltage to the first value or the second value less than the first value, based on the input voltage and the load, and adjust the on-time based on a difference between the set PFC voltage and an actual PFC voltage.

The controller may be configured to increase the on-time of the PFC circuit when the difference between the set PFC voltage and the actual PFC voltage exceeds a preset reference value more than the on-time of the PFC when the difference between the set PFC voltage and the actual PFC voltage is less than or equal to the preset reference value.

The controller may be configured to set the on-time of the PFC circuit when the difference between the set PFC voltage and the actual PFC voltage exceeds a preset reference value, as a value acquired by multiplying the on-time when the difference between the set PFC voltage and the actual PFC voltage is less than or equal to the preset reference value by a predetermined value.

The controller may be configured to acquire the on-time based on a first curve when the difference between the set PFC voltage and the actual PFC voltage is less than or equal to the preset reference value, and acquire the on-time based on a second curve acquired by multiplying the first curve by a predetermined value when the difference between the set PFC voltage and the actual PFC voltage exceeds the preset reference value.

The controller may be configured to set the PFC voltage to a first value or a second value less than the first value, based on the load, when the input voltage is greater than a preset reference voltage, and set the PFC voltage to the second value when the input voltage is less than the reference voltage.

The PFC circuit may further include a PFC voltage sensing unit configured to sense the actual PFC voltage.

### Advantageous Effects of Invention

According to an embodiment of the present disclosure, a power factor corrector (PFC) voltage is varied according to an input voltage. Accordingly, when the input voltage is low, interference with an AC filter can be suppressed, and thus, there is an advantage that can improve noise and heat generation problems.

In addition, since the PFC voltage is varied according to the input voltage, there is an advantage that improves the disadvantage in that efficiency is reduced when the input voltage is high.

According to an embodiment of the present disclosure, there is an advantage in that the problem that an electronic device is turned off due to an occurrence of under-voltage can be improved by adjusting on-time based on a difference between a set PFC voltage and an actual PFC voltage.

### BRIEF DESCRIPTION OF DRAWINGS

FIG. 1 is a diagram illustrating an example of a power factor corrector (PFC) circuit.

FIGS. 2 and 3 are diagrams illustrating a state in which a conventional PFC voltage is fixed and output.

FIG. 4 is a diagram illustrating a PFC circuit according to an embodiment of the present disclosure.

FIG. 5 is a flowchart illustrating an operating method of a PFC circuit according to an embodiment of the present disclosure.

FIG. 6 is a diagram illustrating a state in which a PFC circuit according to an embodiment of the present disclosure outputs a PFC voltage by taking into account an input voltage.

FIG. 7 is a diagram illustrating a state in which a PFC circuit according to an embodiment of the present disclosure outputs a PFC voltage by taking into account a load.

FIG. 8 is a graph showing the efficiency improvement effect acquired as a PFC circuit according to an embodiment of the present disclosure varies a PFC voltage.

FIG. 9 is a diagram for describing a state in which interference with an AC filter is minimized when a PFC voltage of a PFC circuit according to an embodiment of the present disclosure is varied.

FIG. 10 is a diagram illustrating a state in which an under-voltage phenomenon occurs due to rapid fluctuation of a load.

FIG. 11 is a flowchart illustrating an operating method of a PFC circuit according to an embodiment of the present disclosure for preventing an occurrence of under-voltage.

FIG. 12 illustrates an example of data in which on-time is mapped according to a difference between a target PFC voltage stored in a PFC circuit according to an embodiment of the present disclosure and an actual PFC voltage.

FIG. 13 is a diagram illustrating a state in which under-voltage is minimized in a PFC circuit according to an embodiment of the present disclosure.

### BEST MODE FOR CARRYING OUT THE INVENTION

Hereinafter, embodiments related to the present disclosure will be described in more detail with reference to the drawings. The suffixes “module” and “unit” for components used in the description below are assigned or mixed in consideration of easiness in writing the specification and do not have distinctive meanings or roles by themselves.

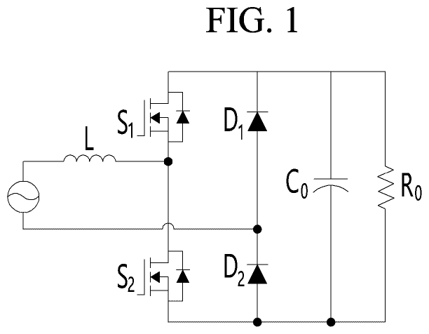

FIG. 1 is a diagram illustrating an example of a PFC circuit.

The PFC circuit is a power factor corrector circuit used to improve a power factor of an input power.

The configuration of the PFC circuit may be diverse, and one example thereof may be the same as illustrated in FIG. 1. The present disclosure may be applied to various types of PFC circuits as well as the PFC circuit illustrated in FIG. 1.

The PFC circuit may include an inductor L, at least one switch S₁ and S₂, at least one diode D₁ and D₂, and a capacitor Co. In the PFC circuit, when the input AC power is positive (+), only the first switch S₁ and the first diode Di are operated. By turning only the first switch Si on and off, the first diode D₁ may charge the capacitor Co. In addition, when the input AC power is negative (−), only the second switch S₂ and the second diode D₂ are operated. By turning only the second switch S₂ on and off, the capacitor Co may be charged. In this manner, the PFC circuit may output a PFC voltage with improved power factor of the input voltage by switching the first and second switches S₁ and S₂. Meanwhile, conventionally, a PFC voltage was fixed.

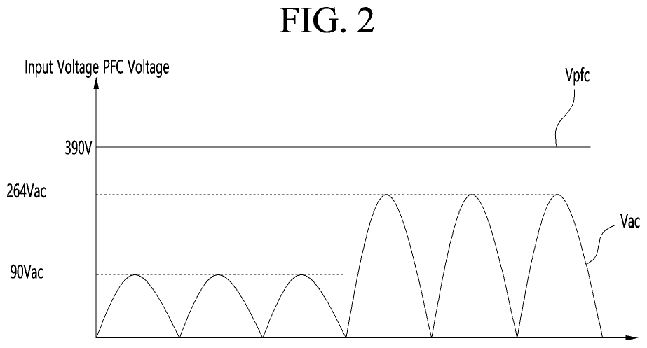

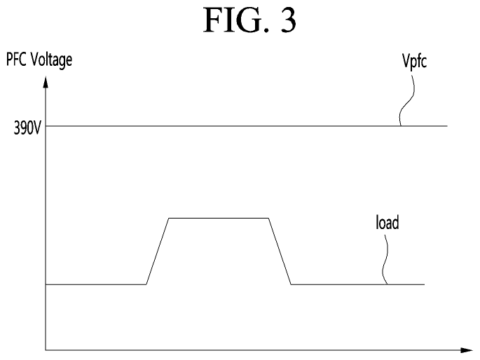

FIGS. 2 and 3 are diagrams illustrating a state in which a conventional PFC voltage is fixed and output. FIG. 2 illustrates a state in which the PFC voltage is fixed and output, regardless of the input voltage, and FIG. 3 illustrates a state in which the PFC voltage is fixed and output, regardless of the load.

Referring to FIG. 2, it can be confirmed that the PFC voltage Vpfc is 390 V even when the input voltage Vac is 90 Vac, and the PFC voltage is output as 390 V even when the input voltage is 264 Vac.

Referring to FIG. 3, it can be confirmed that the PFC voltage Vpfc is fixed to 390 V, regardless of whether the load increases or decreases.

In this case, when the PFC voltage is fixed, there occurs a problem in that the number and the size of components in the AC filter increase so as to suppress interference between the resonant frequency of the AC filter and the operating frequency of the PFC circuit at a low input voltage. Conversely, when the PFC voltage is fixed, there is a disadvantage in that the PFC voltage is high even when the load is small at a high input voltage, which reduces efficiency.

In this regard, the present disclosure aims to provide a PFC circuit that varies a PFC voltage based on an input voltage and a load.

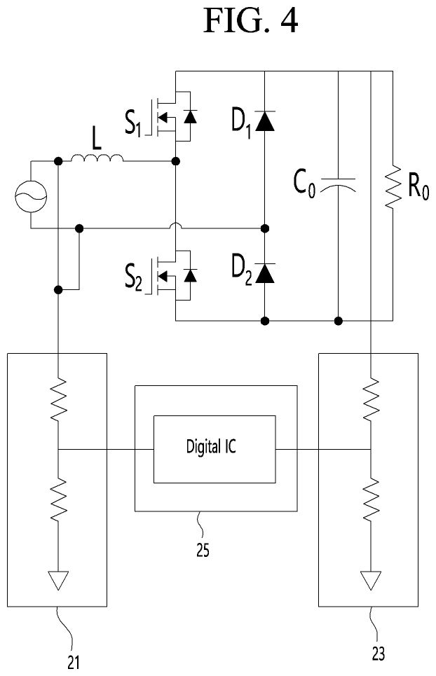

FIG. 4 is a diagram illustrating a PFC circuit according to an embodiment of the present disclosure.

As illustrated in FIG. 4, the PFC circuit according to an embodiment of the present disclosure may include at least some or all of an inductor L, at least one switch S₁ and S₂, at least one diode D₁ and D₂, a capacitor Co, an input voltage sensing unit 21, a PFC voltage sensing unit 23, and a controller 25.

Descriptions redundant with those provided above with reference to FIG. 1 are omitted. The input voltage sensing unit 21 may sense an input voltage. The input voltage sensing unit 21 may transmit the sensed input voltage to the controller 25.

The PFC voltage sensing unit 23 may sense a PFC voltage. The PFC voltage sensing unit 23 may transmit the sensed PFC voltage to the controller 25.

The controller 25 may set the PFC voltage to be output. The controller 25 may receive the input voltage and the PFC voltage. The controller 25 may set the PFC voltage to be output, based on at least one of the input voltage and the PFC voltage.

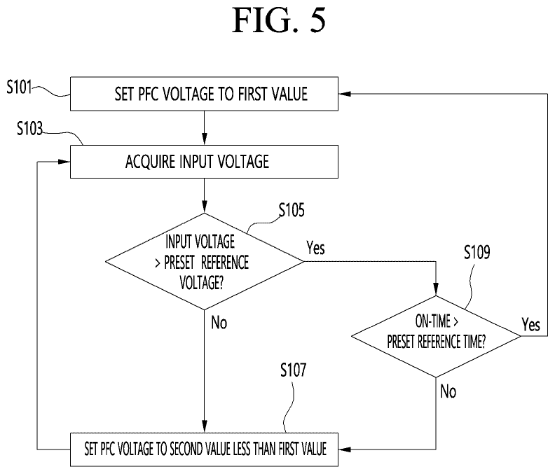

FIG. 5 is a flowchart illustrating an operating method of the PFC circuit according to an embodiment of the present disclosure.

The controller 25 may set the PFC voltage to a first value (S101).

The first value may be 390 V, but this is only an example, and the present disclosure is not limited thereto.

The controller 25 may acquire the input voltage (S103).

The controller 25 may acquire the input voltage sensed by the input voltage sensing unit 21.

The controller 25 may determine the input voltage (S105).

The controller 25 may acquire whether the input voltage is greater than a preset reference voltage. Here, the first voltage may be set to 200 V, but this is only an example, and the present disclosure is not limited thereto.

The controller 25 may determine whether the input voltage is greater than 200 V or less than 200 V. That is, the controller 25 may determine whether the input voltage is of the 200 V series or the 100 V series.

When the input voltage is less than the preset reference voltage, the controller 25 may set the PFC voltage to a second value less than the first value (S107).

The second value may be 360 V, but this is only an example, and the present disclosure is not limited thereto.

Meanwhile, when the input voltage is greater than the preset reference voltage, the controller 25 may determine whether the on-time exceeds a preset reference time (S109).

The on-time may refer to the on-time of the PFC circuit, that is, the on-time of the switches S₁ and S₂ included in the PFC circuit. The reference time may be set to 2.5 us, but this is only an example, and the present disclosure is not limited thereto.

As the load increases, the on-time becomes longer. Thus, the controller 25 may estimate the load based on the on-time. The controller 25 may acquire the load of the electronic device based on the on-time of the PFC circuit. That is, the controller 25 may adjust the PFC voltage based on the load of the electronic device.

The controller 25 may estimate that the load is large when the on-time exceeds the preset reference time and may set the PFC voltage to the first value. The controller 25 may estimate that the load is small when the on-time is less than the reference time and may set the PFC voltage to the second value less than the first value.

That is, when the on-time is greater than the preset reference time, the controller 25 may set the PFC voltage to the first value. That is, when the on-time is greater than the preset reference time, the controller 25 may maintain the PFC voltage at the first value.

When the input voltage is less than the preset reference voltage, the controller 25 may set the PFC voltage to the second value less than the first value. In summary, the controller 25 may determine the load as a high load when the on-time is greater than the preset reference time, and may determine the load as a low load when the on-time is less than the preset reference time. The controller 25 may set the PFC voltage to the first value when the load of the electronic device is high, and may set the PFC voltage to the second value less than the first value when the load of the electronic device is low.

Accordingly, the controller 25 may adjust the PFC voltage according to the input voltage and the load of the electronic device.

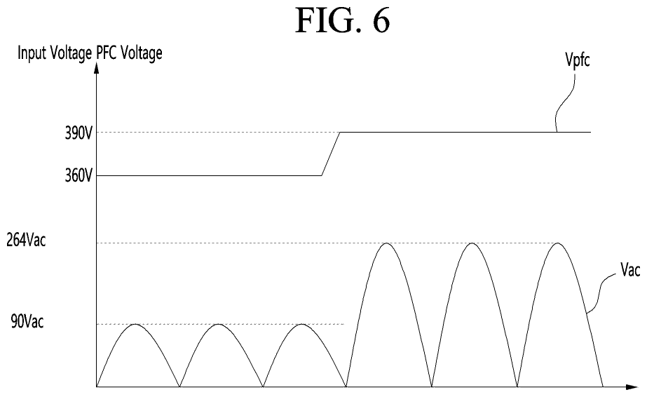

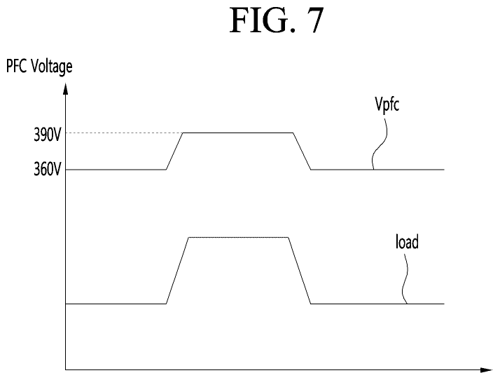

FIG. 6 is a diagram illustrating a state in which the PFC circuit according to an embodiment of the present disclosure outputs the PFC voltage by taking into account the input voltage, and FIG. 7 is a diagram illustrating a state in which the PFC circuit according to an embodiment of the present disclosure outputs the PFC voltage by taking into account the load.

Referring to FIG. 6, it can be confirmed that the PFC voltage Vpfc is 360 V even when the input voltage Vac is 90 Vac, and the PFC voltage is output as 390 V even when the input voltage is 264 Vac. That is, it can be confirmed that the PFC circuit according to an embodiment of the present disclosure adjusts the PFC voltage to a larger value as the input voltage increases, and adjusts the PFC voltage to a smaller value as the input voltage decreases.

Referring to FIG. 7, it can be confirmed that, when the load increases, the PFC voltage Vpfc increases from 360 V to 390 V, and when the load decreases, the PFC voltage decreases from 390 V to 360 V. That is, it can be confirmed that the PFC circuit according to an embodiment of the present disclosure adjusts the PFC voltage according to the load.

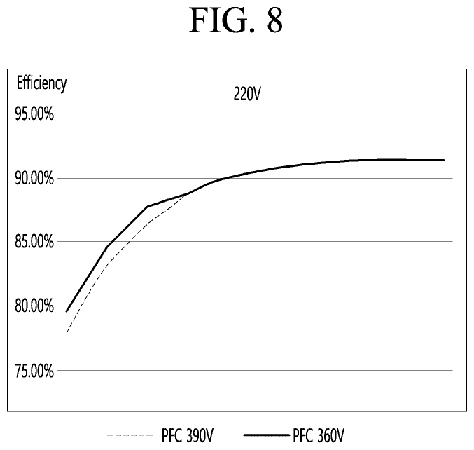

FIG. 8 is a graph showing the efficiency improvement effect acquired as the PFC circuit according to an embodiment of the present disclosure varies the PFC voltage.

In FIG. 8, the horizontal axis represents the load and the vertical axis represents the efficiency. Referring to FIG. 8, it can be confirmed that the efficiency is similar when the PFC voltage is 360 V and 390 V at medium load or higher. However, it can be confirmed that the efficiency when the PFC voltage is 360 V is higher at a low load than the efficiency when the PFC voltage is 390 V. That is, it can be confirmed that the efficiency is improved at a low load as the PFC voltage decreases.

Therefore, it can be confirmed that the efficiency of the PFC circuit is further improved when the PFC voltage is varied so that the PFC voltage is lowered at lower load, compared to a case where the PFC voltage is fixed.

In addition, there is an advantage of preventing interference with the AC filter when the PFC voltage is varied.

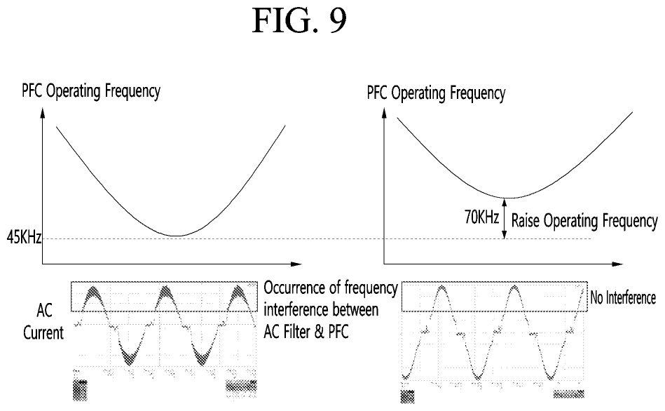

FIG. 9 is a diagram for describing a state in which interference with the AC filter is minimized when the PFC voltage of the PFC circuit according to an embodiment of the present disclosure is varied.

The AC filter may be disposed in front of the PFC circuit. The AC filter may be configured with a combination of a common coil and an X-cap. The resonant frequency of the AC filter may be determined by the common coil and the X-cap and may be, for example, 45 kHz. When the PFC voltage is fixed at 390 V, the operating frequency may be reduced to about 45 kHz, which may cause interference between the AC filter and the PFC circuit.

However, in the PFC circuit according to an embodiment of the present disclosure, the PFC voltage is varied. Accordingly, when the PFC voltage is adjusted to be low, the PFC operating frequency may be reduced to only about 70 kHz. That is, by adjusting the PFC voltage, the minimum value of the PFC operating frequency may be increased by about 70 kHz, and thus, interference with the AC filter may be minimized.

Therefore, there is no need to increase the number of common coil and X-cap components so as to minimize interference with the AC filter, thereby minimizing cost and size increase. In addition, since interference with the AC filter is minimized by only varying the PFC voltage, there is an advantage that improves noise and heat generation problems caused by interference.

Meanwhile, rapid load fluctuations may occur depending on the load. For example, in the case of OLED TV, there are cases where the load momentarily changes from maximum (Max) to minimum (0) or vice versa. At this time, an under-voltage phenomenon in which the PFC voltage decreases below the set value, and thus, a problem in that power is turned off may occur.

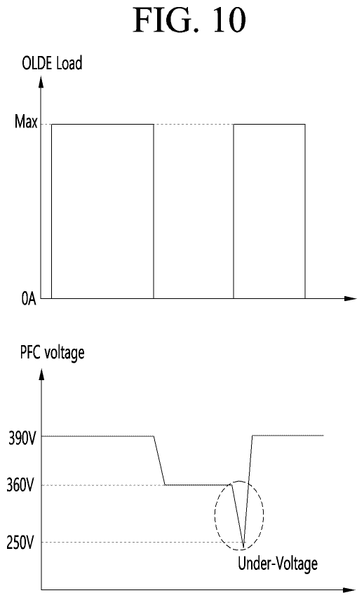

FIG. 10 is a diagram illustrating a state in which the under-voltage phenomenon occurs due to rapid fluctuation of the load.

Referring to the example of FIG. 10, when the load is reduced from maximum (Max) to minimum (0), the PFC voltage may be lowered from the first value (390 V) to the second value (360 V). When the load fluctuates from minimum (0) to maximum (Max) in a state in which the PFC voltage is set to the second value (360 V), the PFC voltage is set to increase from the second value to the first value, but the actual PFC voltage may be reduced due to a rapid change in the load. In particular, as illustrated in FIG. 10, the actual PFC voltage may be reduced to about 250 V. This may cause a power-off problem because the actual PFC voltage is lower than the minimum input voltage (about 300 V) of the LLC resonant converter that receives the PFC voltage.

Accordingly, the PFC circuit according to an embodiment of the present disclosure rapidly increases the PFC voltage by adjusting the on-time using the difference between the target PFC voltage and the actual PFC voltage, thereby minimizing an occurrence of an under-voltage phenomenon.

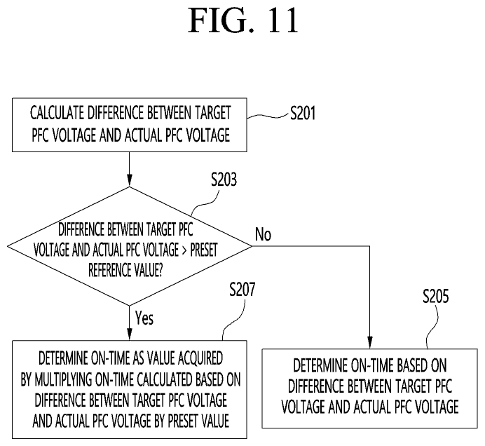

FIG. 11 is a flowchart illustrating an operating method of the PFC circuit according to an embodiment of the present disclosure for preventing an occurrence of under-voltage.

The controller 25 may perform operations according to the flowchart illustrated in FIG. 11 while operating according to the flowchart described with reference to FIG. 5. Specifically, the controller 25 may set the PFC voltage to the first value or the second value less than the first value based on the input voltage and the load, and may adjust the on-time based on the difference between the set PFC voltage and the actual PFC voltage. This will be described in detail below.

The controller 25 may calculate the difference between the target PFC voltage and the actual PFC voltage (S201).

The target PFC voltage may be a voltage set based on at least one of the input voltage and the on-time. The target PFC voltage may be the first value or the second value set in FIG. 5.

The actual PFC voltage may be a current PFC voltage.

The controller 25 may determine whether the difference between the target PFC voltage and the actual PFC voltage is greater than the preset reference value (S203).

When the difference between the target PFC voltage and the actual PFC voltage is less than the preset reference value, the controller 25 may determine the on-time based on the difference between the target PFC voltage and the actual PFC voltage (S205).

Meanwhile, when the difference between the target PFC voltage and the actual PFC voltage is greater than the preset reference value, the controller 25 may determine the on-time as a value acquired by multiplying the on-time calculated based on the difference between the target PFC voltage and the actual PFC voltage by a preset value (S207).

That is, the controller 25 may increase the on-time of the PFC circuit when the difference between the set PFC voltage and the actual PFC voltage exceeds the preset reference value and the difference between the set PFC voltage and the actual PFC voltage is less than the preset reference value.

According to an embodiment, the PFC circuit may store data in which the difference between the target PFC voltage and the actual PFC voltage and the on-time are mapped so that the difference between the target PFC voltage and the actual PFC voltage is proportional to the on-time.

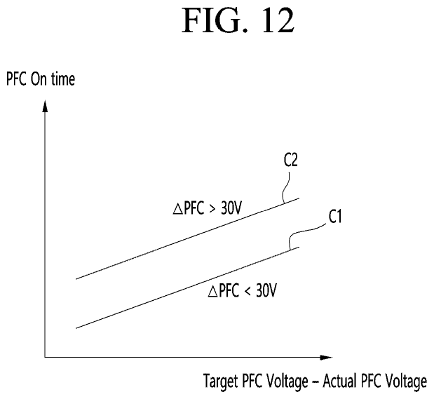

FIG. 12 illustrates an example of data in which the on-time is mapped according to the difference between the target PFC voltage stored in the PFC circuit according to an embodiment of the present disclosure and the actual PFC voltage.

The PFC circuit may store a first curve C1 in which the on-time is mapped according to the difference between the target PFC voltage and the actual PFC voltage when the difference between the target PFC voltage and the actual PFC voltage is less than the preset reference value, and a second curve C2 in which the on-time is mapped according to the difference between the target PFC voltage and the actual PFC voltage when the difference between the target PFC voltage and the actual PFC voltage is greater than the preset reference value.

The reference value may be 30 V, but this is only an example, and the present disclosure is not limited thereto.

Meanwhile, the on-time of the second curve C2 may be a value acquired by multiplying the on-time of the first curve C1 by a predetermined value (e.g., 1.5). That is, the on-time of the second curve C2 when the difference between the target PFC voltage and the actual PFC voltage is the same may be a value acquired by multiplying the on-time of the first curve C1 by a predetermined value. That is, the controller 25 may acquire the on-time based on the first curve C1 when the difference between the set PFC voltage and the actual PFC voltage is less than or equal to the preset reference value, and may acquire the on-time based on the second curve C2 acquired by multiplying the first curve (particularly, a Y value) by a preset value when the difference between the set PFC voltage and the actual PFC voltage exceeds the preset reference value.

When the difference between the target PFC voltage and the actual PFC voltage is greater than the preset reference value, the controller 25 may determine the on-time as a value acquired by multiplying the on-time acquired based on the first curve C1 by a predetermined value, or may determine the on-time as the on-time acquired based on the first curve C1.

Accordingly, the controller 25 may minimize under-voltage by increasing the on-time when the difference between the target PFC voltage and the actual PFC voltage is great so as to quickly increase the PFC voltage.

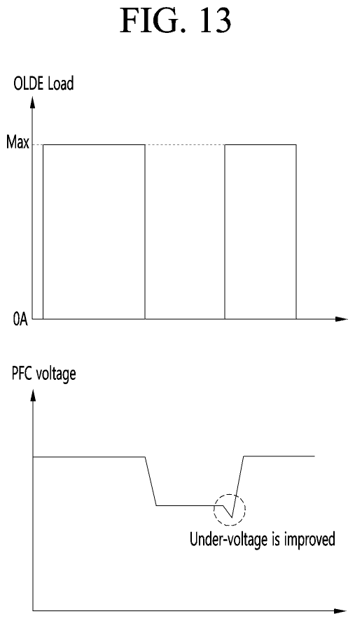

FIG. 13 is a diagram illustrating a state in which under-voltage is minimized in the PFC circuit according to an embodiment of the present disclosure.

Referring to the example of FIG. 13, when the load is reduced from maximum (Max) to minimum (0), the PFC voltage may be lowered from the first value (390 V) to the second value (360 V). When the load fluctuates from minimum (0) to maximum (Max) in a state in which the PFC voltage is set to the second value (360 V), the PFC voltage may be set to increase from the second value to the first value. At this time, when the actual PFC voltage decreases due to a rapid change in the load and the difference between the first value and the actual PFC voltage is greater than the preset reference value, the on-time may be set to a value acquired by multiplying the on-time mapped to the difference between the target PFC voltage and the actual PFC voltage by a preset value. Accordingly, since the actual PFC voltage increases rapidly, an occurrence of under-voltage may be improved.

According to an embodiment of the present disclosure, the above-described method may be implemented with codes readable by a processor on a medium having the program recorded thereon. Examples of the processor-readable medium may include read-only memory (ROM), random access memory (RAM), compact disc read-only memory (CD-ROM), magnetic tape, floppy disk, and optical data storage device.

The PFC circuit described above is not limitedly applicable to the configuration and method of the above-described embodiments, and the embodiments are configured by selectively combining all or part of each of the embodiments such that various modifications can be made.

The above description is only an example of the technical idea of the present disclosure, and those of ordinary skill in the art will appreciate that various modifications and variations may be made without departing from the essential characteristics of the present disclosure.

Therefore, the embodiments disclosed in the present disclosure are not intended to limit the technical idea of the present disclosure but to explain the present disclosure, and the scope of the technical idea of the present disclosure is not limited by these embodiments.

The scope of protection of the present disclosure should be interpreted by the appended claims, and all technical ideas within the scope equivalent thereto should be interpreted as being included in the scope of the rights of the present disclosure.

1. A power factor corrector (PFC) circuit for outputting a PFC voltage by compensating for a power factor of an input voltage of an electronic device, the PFC circuit comprising:
a sensing unit configured to acquire the input voltage; and
a controller configured to adjust the PFC voltage based on at least one of the input voltage and a load of the electronic device.

2. The PFC circuit of claim 1, wherein the controller is configured to:
set the PFC voltage to a first value when the load of the electronic device is a high load; and
set the PFC voltage to a second value less than the first value when the load of the electronic device is a low load.

3. The PFC circuit of claim 1, wherein the controller is configured to acquire the load of the electronic device based on on-time of the PFC circuit.

4. The PFC circuit of claim 3, wherein the controller is configured to:
determine the load as a high load when the on-time is greater than a preset reference time; and
determine the load as a low load when the on-time is less than the reference time.

5. The PFC circuit of claim 1, wherein the controller is configured to:
set the PFC voltage to the first value or the second value less than the first value, based on the input voltage and the load; and
adjust an on-time based on a difference between the set PFC voltage and an actual PFC voltage.

6. The PFC circuit of claim 5, wherein the controller is configured to increase the on-time of the PFC circuit when the difference between the set PFC voltage and the actual PFC voltage exceeds a preset reference value more than the on-time of the PFC when the difference between the set PFC voltage and the actual PFC voltage is less than or equal to the preset reference value.

7. The PFC circuit of claim 5, wherein the controller is configured to set the on-time of the PFC circuit when the difference between the set PFC voltage and the actual PFC voltage exceeds a preset reference value, as a value acquired by multiplying the on-time when the difference between the set PFC voltage and the actual PFC voltage is less than or equal to the preset reference value by a predetermined value.

8. The PFC circuit of claim 5, wherein the controller is configured to:
acquire the on-time based on a first curve when the difference between the set PFC voltage and the actual PFC voltage is less than or equal to the preset reference value; and
acquire the on-time based on a second curve acquired by multiplying the first curve by a predetermined value when the difference between the set PFC voltage and the actual PFC voltage exceeds the preset reference value.

9. The PFC circuit of claim 1, wherein the controller is configured to:
set the PFC voltage to a first value or a second value less than the first value, based on the load, when the input voltage is greater than a preset reference voltage; and
set the PFC voltage to the second value when the input voltage is less than the reference voltage.

10. The PFC circuit of claim 5, further comprising a PFC voltage sensing unit configured to sense the actual PFC voltage.
